(19) United States
(12) Patent Application Publication
(10) Pub. No.: US 2020/0240751 A1
(43) Pub. Date: Jul. 30, 2020

(54) LONG-RANGE LASER RANGEFINDER

(71) Applicant: Cubic Corporation, San Diego, CA (US)

(72) Inventors: Tony Maryfield, Poway, CA (US); Mahyar Dadkhah, San Diego, CA (US); Christian Cugnetti, San Diego, CA (US)

(73) Assignee: Cubic Corporation, San Diego, CA (US)

(21) Appl. No.: 16/378,836

(22) Filed: Apr. 9, 2019

Related U.S. Application Data
(63) Continuation-in-part of application No. 15/065,724, filed on Mar. 9, 2016, now Pat. No. 10,379,135.
(60) Provisional application No. 62/655,113, filed on Apr. 9, 2018.
(60) Provisional application No. 62/130,349, filed on Mar. 9, 2015.
(60) Provisional application No. 62/131,734, filed on Mar. 11, 2015.
(60) Provisional application No. 62/137,094, filed on Mar. 23, 2015.
(60) Provisional application No. 62/137,097, filed on Mar. 23, 2015.
(60) Provisional application No. 62/137,100, filed on Mar. 23, 2015.
(60) Provisional application No. 62/137,111, filed on Mar. 23, 2015.
(60) Provisional application No. 62/138,237, filed on Mar. 25, 2015.
(60) Provisional application No. 62/138,240, filed on Mar. 25, 2015.
(60) Provisional application No. 62/138,895, filed on Mar. 26, 2015.
(60) Provisional application No. 62/140,147, filed on Mar. 30, 2015.
(60) Provisional application No. 62/144,230, filed on Apr. 7, 2015.
(60) Provisional application No. 62/144,837, filed on Apr. 8, 2015.
(60) Provisional application No. 62/145,413, filed on Apr. 9, 2015.

(51) Int. Cl. F41G 3/06; G01S 7/481; G01S 17/10

(52) U.S. Cl. CPC F41G 3/065; G01S 7/4817; G01S 17/10; G01S 7/4814; G01S 7/4816

(57) ABSTRACT

Embodiments disclosed herein address these and other issues by providing for a long range ballistic laser rangefinder system that helps overcome these and other obstacles. In particular, embodiments of a laser rangefinder system utilize a laser transmitter assembly with a fiber laser for generating a plurality of laser pulses that are reflected off of a target and received at a light receiver assembly that includes a light detector for detecting the reflected laser pulses. The plurality of reflected laser pulses are then used to determine an accurate distance from the laser rangefinder system to the target. This can include, for example, taking an average of the distances calculated using each of the plurality of reflected laser pulses.

### CROSS-REFERENCES TO RELATED APPLICATIONS

This application claims the benefit of U.S. Provisional Patent Application No. 62/655,113, filed Apr. 9, 2018, entitled “LONG RANGE BALLISTIC LASER RANGEFINDER SYSTEM,” which is assigned to the assignee hereof and incorporated by reference herein in its entirety.

### BACKGROUND

A laser rangefinder is a device that uses a laser beam to determine the distance to an object, typically by sending a laser pulse towards the object and measuring the time taken by the pulse to be reflected off the target and returned to the laser rangefinder. But traditional laser rangefinders suffer from a variety of ill effects, such as spotty, irregular laser beam quality, poor bore-sight retention, and excessive time taken to determine the range. Such issues can be particularly problematic in certain applications, such as in sniper applications, where speed and accuracy of range determination may impact whether a sniper is able to take a shot during a brief window of opportunity.

### BRIEF SUMMARY

Embodiments disclosed herein address these and other issues by providing for a long range ballistic laser rangefinder system that helps overcome these and other obstacles. In particular, embodiments of a laser rangefinder system utilize a laser transmitter assembly with a fiber laser for generating a plurality of laser pulses that are reflected off of a target and received at a light receiver assembly that includes a light detector for detecting the reflected laser pulses. The plurality of reflected laser pulses are then used to determine an accurate distance from the laser rangefinder system to the target. This can include, for example, taking an average of the distances calculated using each of the plurality of reflected laser pulses.

An example laser rangefinder system, according to the description, comprises a laser transmitter assembly comprising a fiber laser, and a laser steering assembly configured to steer laser light generated by the fiber laser. The laser rangefinder system further includes a laser receiver assembly comprising a light sensor, and receiving optics configured to direct reflected laser light toward the light sensor. The laser rangefinder system further includes a processing unit communicatively coupled with the laser system and the laser receiver and configured to cause the laser transmitter assembly to emit the laser light, wherein the laser light comprises a plurality of laser pulses, and receive, from the light receiver assembly, information regarding a plurality of reflected laser pulses detected by the light sensor, wherein the reflected laser pulses correspond to the plurality of laser pulses reflecting off of a target. The processing unit is further configured to determine, from the plurality of reflected laser pulses, a distance from the laser rangefinder system to the target.

An example method of performing a laser range measurement with a laser rangefinder system, according to the description, comprises transmitting, with a fiber laser of the laser rangefinder system, laser light through a laser steering assembly toward a target, wherein the laser light comprises a plurality of laser pulses. The method further includes receiving, with a laser receiver assembly of the laser rangefinder system, reflected laser light comprising a plurality of reflected laser pulses corresponding to the plurality of laser pulses transmitted with the fiber laser reflecting off of the target, wherein the laser receiver assembly directs the reflected laser light toward a light sensor. The method also includes obtaining, at a processing unit of the laser rangefinder system, information from the light sensor indicative of a time at which each of the plurality of reflected laser pulses was detected by the light sensor, and determining, with the processing unit of the laser rangefinder system, a distance from the laser rangefinder system to the target based on the time at which each of the plurality of reflected laser pulses was detected by the light sensor.

### BRIEF DESCRIPTION OF THE DRAWINGS

For a more complete understanding of this invention, reference is now made to the following detailed description of the embodiments as illustrated in the accompanying drawings, in which like reference designations represent like features throughout the several views and wherein:

FIG. 1 is an illustration of an example weapon-mounted rangefinding configuration, according to an embodiment;

FIG. 2 is a simplified illustration of the basic operation of the laser rangefinder system, according to an embodiment;

FIG. 3 is a block diagram of a laser rangefinder system, according to an embodiment;

FIG. 4 is a cutaway illustration of a particular form factor of a laser rangefinder system, according to an embodiment; and

FIG. 5 is a process flow diagram of a method of performing a laser range measurement with a laser rangefinder system, according to an embodiment.

In the appended figures, similar components and/or features may have the same reference label. Further, various components of the same type may be distinguished by following the reference label by a dash and a second label that distinguishes among the similar components. If only the first reference label is used in the specification, the description is applicable to any or all of the similar components having the same first reference label irrespective of the second reference label.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

Laser rangefinders can be mounted to and used in conjunction with another apparatus, such as a weapon and/or optical scope. In military applications, laser rangefinders can be mounted to weapons or spotting scopes to enable tracking of a target and increase accuracy in aiming the weapon. In such applications, a laser rangefinder may be “bore-sighted” to (i.e., co-aligned with) an apparatus (e.g., scope and/or weapon) such that a laser of the laser rangefinder illuminates a target at which the apparatus is aimed. This ensures the accuracy of range measurements taken by a laser rangefinder with respect to the target. Laser rangefinders utilized by snipers can bring an added degree of sophistication because they may be able to measure conditions, in addition to a range, that can impact long-range shots. Such factors can include, for example, wind, elevation, and more.

As previously noted, traditional rangefinding solutions can be inadequate for certain applications. Frequently, for example, traditional laser rangefinders may utilize a single, high-power laser pulse to determine a range, but this can be problematic in several aspects. For example, high-power laser pulses often suffer in the quality, which can often result in poor range resolution. Additionally, a single pulse is subject to atmospheric effects that can impact the direction and strength of the pulse, which can additionally lead to inaccuracy in range determination. Weaker pulses can lead to long lag times correlating pulses to determine a distance.

In addition to the problems above, traditional laser rangefinders often have a receiver with a relatively small field of view (FOV), making bore-sighting difficult, and, even when bore sighted, is still subject to temperature drift.

Embodiments discussed herein address these and other issues by providing a laser rangefinder system that utilizes a fiber laser with a single-mode fiber that generates a clean, sharp beam. The fiber laser can be used to generate a series of pulses that can be averaged over a short period of time, providing a highly accurate range measurement at long distances. Embodiments may further utilize a wide FOV receiver that can facilitate bore sighting, accommodate temperature drift, and provide a shorter focal length to reduce the overall size of the laser rangefinder system. Additional details are provided herein below.

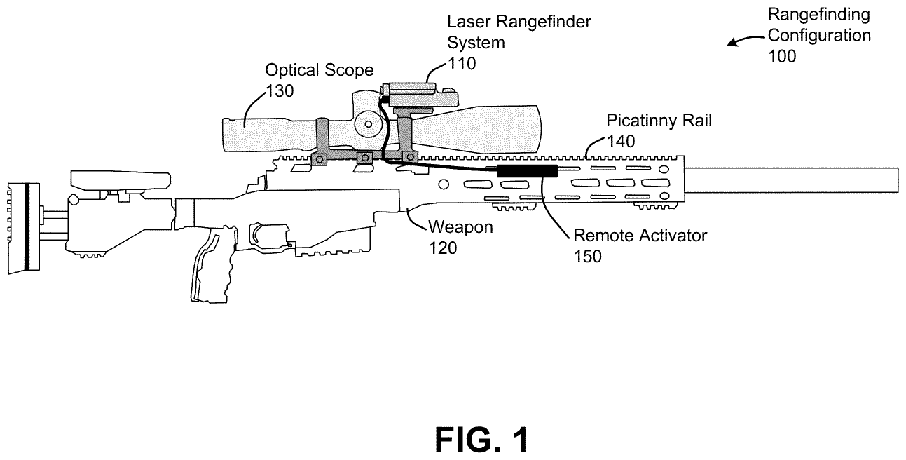

FIG. 1 is an illustration of an example weapon-mounted rangefinding configuration 100, according to an embodiment. Here, a laser rangefinder system 110 is mounted on a weapon 120 above an optical scope 130. Here, both the laser rangefinder system 110 and optical scope 130 are mounted to the weapon 120 via a Picatinny rail 140 (which offers a standard rail interface system for mounting firearm accessories). They can be understood that embodiments may accommodate different configurations. For example, the laser rangefinder system 110 may be mounted in front of or below the optical scope 130. Moreover, alternative configurations may omit the optical scope 130 entirely. In alternative configurations, the laser rangefinder system 110 may be mounted to a spotting scope or other non-weapon apparatus.

Although embodiments of the laser rangefinder system 110 may include a user interface (e.g., buttons, switches, display, etc.), Embodiments may additionally or alternatively include an interface by which a remote activator 150 may be coupled to the laser rangefinder system 110 to provide a basic input to the laser rangefinder system 110. As illustrated in FIG. 1, for example, the remote activator 150 comprises a mountable button, switch, touchpad, and/or other user-activated interface communicatively coupled with the laser rangefinder system 110 can be mounted to an easily-reachable location on the weapon 120 to allow a user to initiate rangefinding by the laser rangefinder system 110 while viewing a target through the optical scope 130. That is, because both the laser rangefinder system 110 and optical scope 130 may be bore sighted to the weapon 120, a user can view a target through the optical scope 130 and activate the remote activator 150 to cause the laser rangefinder system 110 to determine a range to the target, and provide the range to the user. The range may be provided via a display located on the laser rangefinder system 110 and/or within a display viewable through the optical scope 130. In the latter case, the laser rangefinder system 110 may have an electronic interface to allow the laser rangefinder system 110 to communicate the range to a display of the optical scope 130. This can allow a user to determine the range of a target viewable within the optical scope 130 without having to look elsewhere for the range determination.

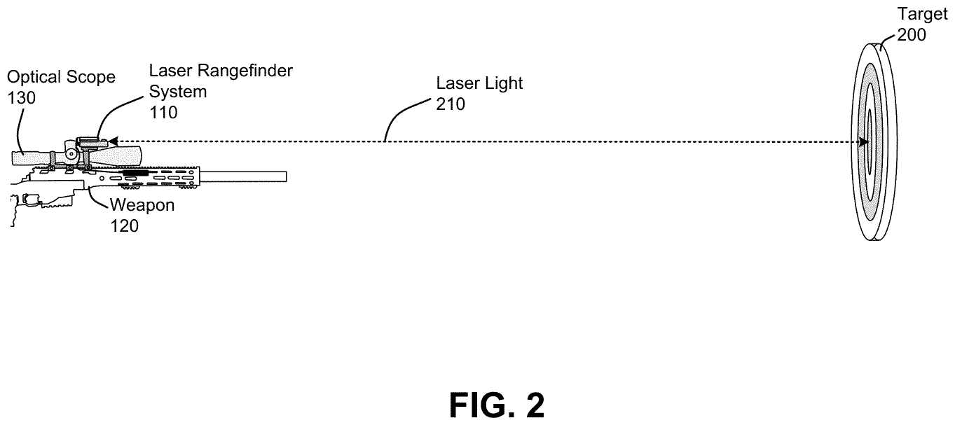

FIG. 2 is a simplified illustration of the basic operation of the laser rangefinder system 110, according to an embodiment. Again, the laser rangefinder system 110 and optical scope 130 may be bore sighted to the weapon 120, allowing a user to use the optical scope 130 to aim the weapon 120 at a target 200, then activate the laser rangefinder system 110 (e.g., via a remote activator) to determine a distance to the target 200. (Although the laser rangefinder system 110 may utilize an infrared or other non-visible laser light 210 for laser range determination, the laser rangefinder system 110 may further include a coaxial visible red laser to facilitate the bore-sighting process.)

As a person of ordinary skill in the art will appreciate, rangefinding involves determining a time of flight between when a laser pulse is transmitted, and when the laser pulse's reflection is detected. Accordingly, when activated, the laser rangefinder system 110 will transmit laser light 210 toward the target 200 in the form of one or more pulses, which will reflect off of the target 200 and be detected by a receiver of the laser rangefinder system 110.

As previously noted, embodiments may utilize a plurality of pulses to help increase the accuracy of range determination. As previously noted, atmospheric effects can impact the accuracy of range determinations. Large swings in scintillation, for example, can cause atmospheric fades of a single pulse that exceed 45 dB. Using laser light 210 comprising multiple pulses, however, can help overcome short-term, large swings in scintillation, while increasing signal-to-noise ratio (SNR). In some embodiments, for example, the laser rangefinder system 110 can provide a burst of pulses, repeated at 50 kHz, over the course of approximately 100 ms, where the pulse energy for each pulse is 20 μJ. moreover, the fiber laser of the laser rangefinder system 110 can provide a relatively tight beam (e.g., 300 μrad). This can allow embodiments of the laser rangefinder system 110 to provide particularly accurate rangefinding at distances of 1500 m or more.

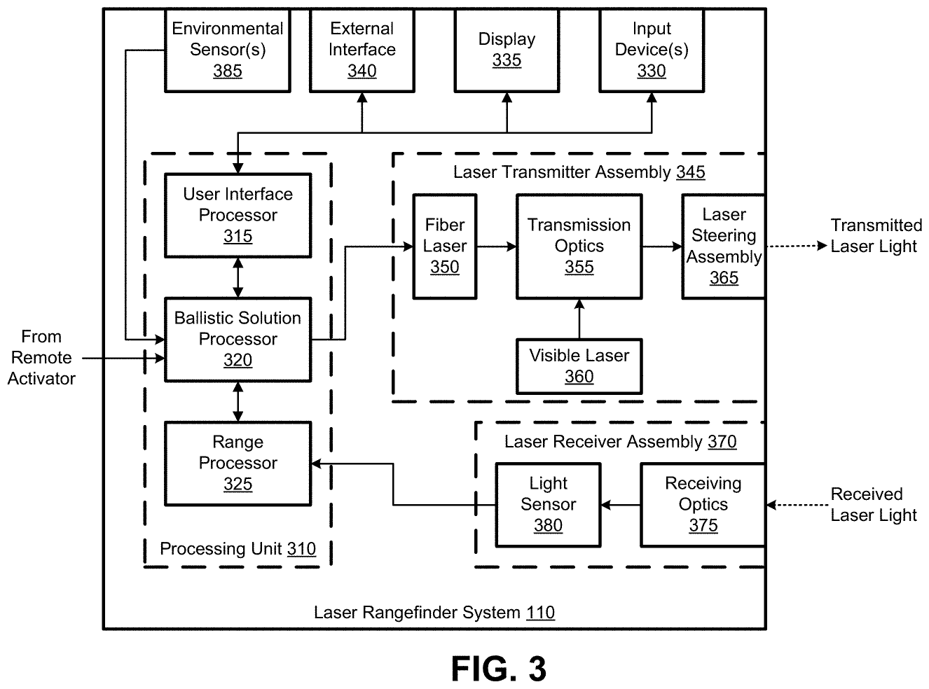

FIG. 3 is a block diagram of a laser rangefinder system 110, according to an embodiment. As with other figures provided herein, FIG. 3 is provided as a non-limiting example. Embodiments may include some components that are not illustrated (e.g., a power supply). Moreover, alternative embodiments may combine, separate, rearrange, or otherwise alter the configuration of components illustrated in FIG. 3. A person of ordinary skill in the art will appreciate such variations. Arrows between components illustrated electronic and/or optical connections between components.

The processing unit 310 may comprise one or more processors generally configured to cause the various components of the laser rangefinder system 110 to make a range calculation, calculate a ballistic solution (according to some embodiments), and operate a user interface. The processing unit 310 may comprise without limitation one or more general-purpose processors (e.g. a central processing unit (CPU), microprocessor, and/or the like), one or more special-purpose processors (such as digital signal processing (DSP) chips, application specific integrated circuits (ASICs), and/or the like), and/or other processing structure or means. It can be noted that, although the processing unit 310 of the embodiment illustrated in FIG. 3 comprises three discrete processors (a user interface processor 315, a ballistic solution processor 320, and a range processor 325), alternative embodiments may include a different configuration of processors (or a single processor) that performs the functions of the three illustrated processors as described below.

One or more individual processors within the processing unit 310 may comprise memory, and/or the processing unit 310 may have a discrete memory (not illustrated). In any case, the memory may comprise, without limitation, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

As previously noted, in the embodiment illustrated in FIG. 3, the processing unit 310 comprises a user interface processor 315, a ballistic solution processor 320, and a range processor 325, which are communicatively coupled with one another. The user interface processor 315 may be configured to operate the various components comprising a user interface, including input device(s) 330, display 335, and/or external interface 340.

The input device(s) 330 may comprise one or more components configured to receive input from a user. This can include, for example, one or more of a keypad, button, switch, touch pad, keyboard, and/or the like, which may vary upon application and complexity. (Military applications, for example, may include a simple, ruggedized interface, whereas commercial applications may include a less-rugged interface that may include more complexity.) Depending on desired functionality, the user interface can provide any of a variety of functions, including activating a visible laser for bore-sighting, initiating a rangefinding measurement, initiating a ballistic solution, navigating a menu, adjusting user interface settings, configuring settings for the external interface 340, and/or the like.

The display 335 may include any of a variety of display types, depending on desired functionality. A simple liquid crystal display (LCD), for example, may be used for low power applications to display a calculated range. Other information such as battery life, ballistic solution, and/or sensor data (barometer, temperature, humidity, cant, elevation, heading, etc.) may also be provided to the user via the display 335. Other display types (light emitting diode (LED), organic LED (OLED), etc.) additionally or alternatively may be used.

The external interface 340 may comprise a communication interface for sending and receiving data to and from one or more external devices. This can include, for example, sending information to an optical scope 130 with an integrated display, enabling the optical scope 130 to display range, ballistic solution, and/or other data from the laser rangefinder system 110. In some embodiments, the external interface 340 may additionally allow for communication from an external device, which can allow the external device to perform certain functions (e.g., initiate a range determination). The external interface 340 may comprise a wired and/or wireless communication interface, depending on desired functionality. In some embodiments where the external interface 340 comprises a wired interface for connecting with an integrated display of an optical scope 130, the external interface 340 may provide power to the integrated display of the optical scope 130, thereby eliminating the need for a power supply (e.g. batteries) in the optical scope 130.

The ballistic solution processor 320 can be configured to initiate the transmission of the laser light for range determination, according to some embodiments. To do so, the ballistic solution processor 320 may be communicatively coupled with the remote activator 150 and laser transmitter assembly 345. For example, upon receiving an input from the remote activator to initiate a range determination, the ballistic solution processor 320 can then initiate the range determination by causing the laser transmitter assembly 345 to transmit laser light.

As illustrated, some embodiments of the laser transmitter assembly 345 may comprise a fiber laser 350, transmission optics 355, a visible laser 360, and a laser steering assembly 365. The fiber laser 350 may comprise a low-cost fiber laser can be used to provide diffraction limited-perfect beam quality with dramatically higher peak power per shot over traditional diode lasers, thereby reducing the time to correlate/average return pulses to measure the range. (For military applications, this reduced time can be significant. Traditional rangefinders taking four seconds or longer to determine a range can result in a lost opportunity for a shooter. However, embodiments herein can provide for a range determination in one second or less.) A fiber laser 350 can result in 10 times more power, two times the efficiency, low speckle, and virtually the same cost as a diode laser. An example fiber laser, according to some embodiments, comprises a glass erbium laser capable of generating a 1550 nm wavelength light pulse with a 10 nm line with. Another example of a low-cost fiber laser is described in U.S. Pat. No. 9,590,385, entitled “Compact Laser Source,” which is incorporated by reference herein in its entirety for all purposes.

Laser light generated by the fiber laser 350 can then be sent through transmission optics 355. As previously indicated, laser light generated by the fiber laser 350 may not be visible (e.g., may be infrared light). Thus, a visible laser 360 (e.g., a red laser) may be used to provide a visible spot for bore-sighting. The light from the visible laser 360 can be sent through the same transmission optics 355 and laser steering assembly 365 to help ensure the visible laser light follows the same optical path as the transmitted laser light from the fiber laser 350. Thus, transmission optics 355 may include a dichroic combiner to combine the optical paths of the light generated by both the visible laser 360 and the fiber laser 350.

The laser steering assembly 365 can allow a user to steer the transmitted laser light to boresight the laser rangefinder system 110 to a weapon 120 and/or scope 130 without needing to make any adjustments to the mounting of the laser ranger transmitter system 110 itself. According to some embodiments, the laser steering assembly may comprise Risley prisms, which can be particularly useful in weapon-mounted applications due to the ability of Risley prisms to stay bore sighted despite environmental temperature drifts and the shock of multiple gunshots. According to some embodiments, a laser steering assembly 365 comprising Risley prisms can allow for ±1 degree of beam steering. Moreover, according to some embodiments, the adjustment of the Risley prisms can be made via a coin slot operated adjustment on the housing, to provide a repeatable, stable adjustment.

As previously noted, transmitted laser light from the fiber laser 350 may comprise a plurality of pulses, which can allow for an accurate range determination despite scintillation and other changes in atmospheric conditions. Moreover, in some embodiments, the fiber laser 350 utilizes a single mode fiber, which can provide a particularly high-power, high-quality pulse. According to some embodiments, for example, the beam quality factor (M²) of the output may be better than 1.2.

The received a laser light, comprising a plurality of the reflected pulses corresponding to the transmitted plurality of pulses, is then received at the laser receiver assembly 370. Here, the laser receiver assembly 370 can comprise receiving optics 375 that direct light to the light sensor 380. The receiving optics 375 may comprise one or more lenses configured to focus the receive laser light onto the light sensor 380. The receiving optics 375 may additionally include filters, such as a sun filter, to increase the SNR by reducing the amount of non-laser light reaching the light sensor 380. In some embodiments, the light sensor 380 may comprise an avalanche photodiode (APD). Other embodiments, however, may utilize one or more other types of light sensors.

In some embodiments, the laser receiver assembly 370 may comprise a wide field of view (WFOV) receiver. This can help ensure the reflected laser light is detected by the laser receiver assembly 370, regardless of where the transmitted laser light is steered. The utilization of an immersion lens in the receiving optics 375 can help the laser receiver assembly 370 achieve a WFOV. An example of a WFOV receiver is described in U.S. Pat. No. 8,558,337, entitled “Wide Field of View Optical Receiver,” which is incorporated by reference herein in its entirety for all purposes.

The range processor 325 can receive an indication from the ballistic solution processor 320 of when the transmitted laser light was transmitted, along with an indication from the light sensor 380 of when the received laser light was received. And thus, the range processor 325 can calculate a range to the target 200. As previously noted, embodiments may use a plurality of transmitted laser pulses and receive a corresponding plurality of reflected laser pulses. Thus, the range processor 325 can determine a range from each pulse transmitted and received. Outlier detection and removal can be done to help increase accuracy of range determinations. One such technique is simply to average the time of flight measurements and/or resulting range calculations to make a single range determination, which can then be provided to the ballistic solution processor 320.

The ballistic solution processor 320 can convey the range to the user interface processor 315 for display of the range determination to the user (e.g., via the display 335 and/or the external interface 340). However, according to some embodiments, the ballistic solution processor 320 can determine a ballistic solution, which can indicate, for example, how the weapon 120 should be positioned in order to accurately hit the target 200. To calculate the ballistic solution, the ballistic solution processor 320 can obtain environmental information from one or more environmental sensors 385.

The environmental sensor(s) 385 may comprise sensors capable of sensing any of a variety of factors that may impact the ballistic solution determined by the ballistic solution processor 320. As such, the environmental sensors 385 may comprise an accelerometer, barometer, gyroscope, magnetometer, thermometer, wind sensor, etc. for detecting elevation, heading, temperature, humidity, crosswind, and/or the like. Although illustrated as being incorporated into the laser rangefinder system 110, the environmental sensor(s) 385 may comprise one or more sensors internal and/or external to the laser rangefinder system 110. As such, the laser rangefinder system 110 may include one or more wired or wireless interfaces for communicating with any external environmental sensor(s) 385.

Once the ballistic solution is determined, the ballistic solution processor 320 can provide the ballistic solution to the user interface processor 315, which can relay the solution to the user via the display 335 and/or external interface 340.

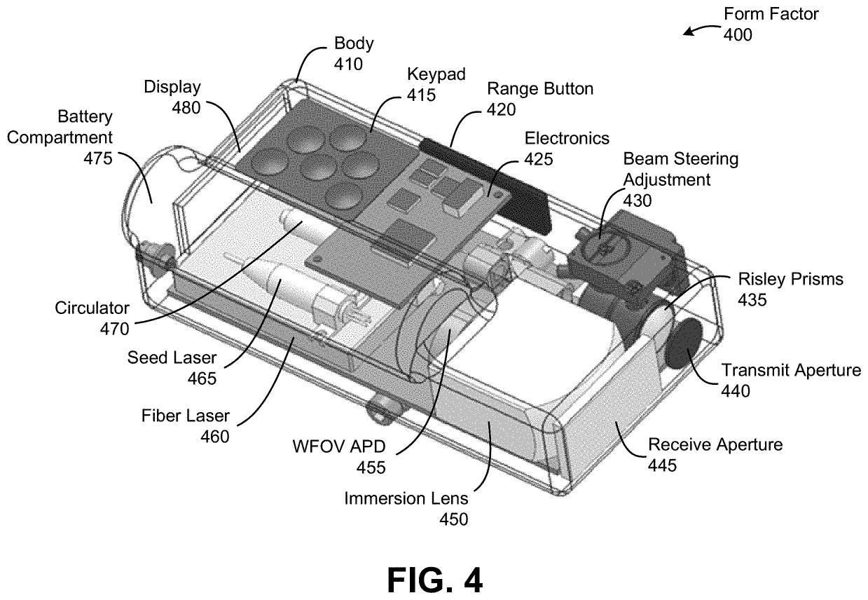

FIG. 4 is a cutaway illustration of a laser rangefinder system 110 having a particular form factor 400 of, according to an embodiment. The illustrated embodiment is particularly compact, being only 128 mm in length, 66 mm in width, and 52 mm in height. It will be understood, however, that alternative embodiments may have different form factors, depending on the application, manufacturing concerns, and/or other factors.

Components of form factor 400 may be coupled with, disposed on, and/or housed within a body 410, which may comprise any of a variety of materials, including aluminum, plastic, etc. A keypad 415 is disposed on a top surface of the body 410 to provide an easily-accessible interface for user input. A range button 420 is located on the side of the body 410, which is connected to electronics 425 housed within the body 410. Here, the electronics 425 may comprise one or more components of the processing unit 310 and/or other electronic components. The range button 420 may allow a user to initiate a range determination, and therefore may be an alternative to using the remote activator 150 (illustrated in FIG. 1). Beam steering adjustment 430 is a coin slot adjustment knob disposed on the top surface of the body 410, and is operable to move the Risley prisms 435 to steer the transmitted laser beam. (The illustrated beam steering adjustment 430 may adjust to the transmitted laser light along one axis, where another beam steering adjustment (e.g., located on the side of the body 410) may adjust the transmitted laser light along a second axis.) Transmitted laser light exits the form factor 400 via the transmit aperture 440. When receiving reflected laser light, the reflected laser light enters the body 410 of the form factor 400 via the receive aperture 445, at which point the reflected laser light is focused by an immersion lens 450 onto a WFOV APD 455.

Other illustrated components include the fiber laser 460 (which includes several subcomponents, such as the seed laser 465 and circulator 470), as well as the battery compartment 475 and display 480. As previously mentioned, the display may comprise any of a variety of display types, such as LCD, LED, etc. The battery compartment 475 may be capable of housing any of a variety of types of batteries, depending on desired functionality. For the form factor 400 illustrated in FIG. 4, the batteries may comprise lithium coin cell batteries. But other embodiments may employ other battery types.

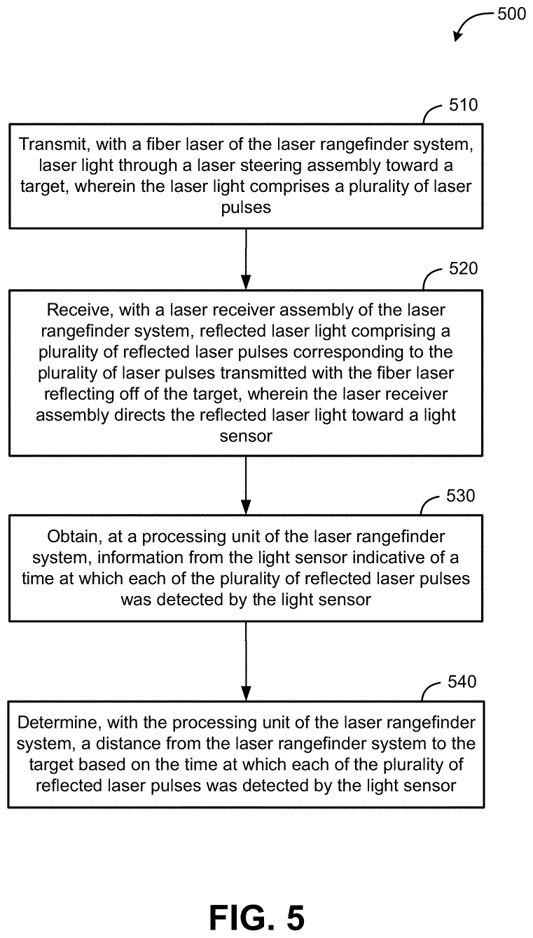

FIG. 5 is a process flow diagram of a method 500 of performing a laser range measurement with a laser rangefinder system, according to an embodiment. Here, the functionality of the blocks illustrated in FIG. 5 may be performed by one or more components of a laser rangefinder, such as components illustrated in FIGS. 3 and 4.

At block 510, the functionality includes transmitting, with a fiber laser of the laser rangefinder system, laser light through a laser steering assembly toward a target, wherein the laser light comprises a plurality of laser pulses. As previously noted, the fiber laser can provide relatively clean, high-power pulses to provide an accurate range determination for relatively long ranges (e.g., 1500 m or more). According to some embodiments, the fiber laser is configured to generate laser light using a single mode fiber. Each pulse of the plurality of pulses may comprise an output pulse energy of at least 10 μJ (e.g., 15 μJ, 20 μJ, or more). Additionally or alternatively, the plurality of laser pulses can be transmitted over a period of less than 200 ms (e.g., 150 ms, 100 ms, 50 ms, etc.). According to some embodiments, the plurality of laser pulses may be transmitted at a rate of at least 25 kHz (e.g., 30 kHz, 40 kHz, 50 kHz, 60 kHz, etc.). As previously noted, the laser steering assembly may comprise Risley prisms.

The functionality at block 520 comprises receiving, with a laser receiver assembly of the laser rangefinder system, reflected laser light comprising a plurality of reflected laser pulses corresponding to the plurality of laser pulses transmitted with the fiber laser reflecting off of the target, wherein the laser receiver assembly directs the reflected laser light toward a light sensor. As previously indicated, the laser receiver assembly may comprise optics such as a sun filter and/or an immersion lens. The light sensor may comprise an APD or other photoelectric sensor.

The functionality at block 530 comprises obtaining, at a processing unit of the laser rangefinder system, information from the light sensor indicative of a time at which each of the plurality of reflected laser pulses was detected by the laser sensor. As noted in the embodiments above, the time at which each of the reflected pulses was detected can be compared with a time at which each of the pulses was originally transmitted, allowing for calculation of the time of flight of each pulse.

At block 540, the functionality comprises determining, with the processing unit of the laser rangefinder system, a distance from the laser rangefinder system to the target based on the time at which each of the plurality of reflected laser pulses was detected by the light sensor. As previously noted, the utilization of a plurality of laser pulses can provide for a particularly accurate range determination. For example, the determination of the distance from the laser rangefinder system to the target may be based on an average time of flight of the plurality of pulses.

As noted in the embodiments above, a laser rangefinder system can additionally provide a ballistic solution based on the distance determination as well as environmental factors. As such, according to some embodiments, the method 500 may further comprise obtaining environmental information from an environmental sensor and determining, with the processing unit of the laser rangefinder system, a ballistic solution based on the determined distance from the target and the information from the environmental sensor. The environmental sensor itself may comprise one or more types of sensors configured to sense one or more types of environmental factors. According to some embodiments, for example, the environmental sensor comprises an inclinometer, thermometer, barometer, humidity sensor, compass (e.g., magnetometer), wind sensor, or any combination thereof. In some embodiments, the method 500 may further comprise causing a display of the laser rangefinder system to show the ballistic solution.

In the embodiments described above, for the purposes of illustration, processes may have been described in a particular order. It should be appreciated that in alternate embodiments, the methods may be performed in a different order than that described. It should also be appreciated that the methods and/or system components described above may be performed by hardware and/or software components (including components illustrated in FIG. 3), or may be embodied in sequences of machine-readable, or computer-readable, instructions, which may be used to cause a machine, such as a general-purpose or special-purpose processor (e.g., processing unit 310 of FIG. 3) or logic circuits programmed with the instructions, to perform the methods. These machine-readable instructions may be stored on one or more machine-readable mediums, such as CD-ROMs or other type of optical disks, floppy disks, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

1. A laser rangefinder system comprising:
a laser transmitter assembly comprising:
a fiber laser, and
a laser steering assembly configured to steer laser light generated by the fiber laser;
a laser receiver assembly comprising:
a light sensor, and
receiving optics configured to direct reflected laser light toward the light sensor;
a processing unit communicatively coupled with the laser system and the laser receiver and configured to:
cause the laser transmitter assembly to emit the laser light, wherein the laser light comprises a plurality of laser pulses;
receive, from the light receiver assembly, information regarding a plurality of reflected laser pulses detected by the light sensor, wherein the reflected laser pulses correspond to the plurality of laser pulses reflecting off of a target; and
determine, from the plurality of reflected laser pulses, a distance from the laser rangefinder system to the target.

2. The laser rangefinder system of claim 1, wherein the laser steering assembly comprises a Risley prism laser steering assembly.

3. The laser rangefinder system of claim 1, wherein the light sensor comprises an Avalanche Photo Diode (APD).

4. The laser rangefinder system of claim 1, further comprising an environmental sensor, wherein the processing unit is further configured to receive information from the environmental sensor, and determine a ballistic solution based on the determined distance from the target and the information from the environmental sensor.

5. The laser rangefinder system of claim 4, wherein the environmental sensor comprises an inclinometer, thermometer, barometer, humidity sensor, compass, or any combination thereof.

6. The laser rangefinder system of claim 4, further comprising a display, wherein the processing unit is further configured to cause the display to show the ballistic solution.

7. The laser rangefinder system of claim 4, further comprising an external electronic interface wherein the processing unit is further communicate the ballistic solution via the external electronic interface.

8. The laser rangefinder system of claim 4, wherein the processing unit comprises a first processor configured to determine the distance from the target and a second processor configured to determine the ballistic solution.

9. The laser rangefinder system of claim 1, wherein the laser system further comprises a red laser and a dichroic combiner.

10. The laser rangefinder system of claim 1, further comprising a keypad configured to receive a user input.

11. A method of performing a laser range measurement with a laser rangefinder system, the method comprising:
transmitting, with a fiber laser of the laser rangefinder system, laser light through a laser steering assembly toward a target, wherein the laser light comprises a plurality of laser pulses;
receiving, with a laser receiver assembly of the laser rangefinder system, reflected laser light comprising a plurality of reflected laser pulses corresponding to the plurality of laser pulses transmitted with the fiber laser reflecting off of the target, wherein the laser receiver assembly directs the reflected laser light toward a light sensor;
obtaining, at a processing unit of the laser rangefinder system, information from the light sensor indicative of a time at which each of the plurality of reflected laser pulses was detected by the light sensor; and
determining, with the processing unit of the laser rangefinder system, a distance from the laser rangefinder system to the target based on the time at which each of the plurality of reflected laser pulses was detected by the light sensor.

12. The method of claim 11, wherein the laser steering assembly comprises a Risley prism laser steering assembly.

13. The method of claim 11, wherein the light sensor comprises an Avalanche Photo Diode (APD).

14. The method of claim 11, further comprising:
obtaining environmental information from an environmental sensor; and
determining, with the processing unit of the laser rangefinder system, a ballistic solution based on the information from the environmental sensor and the determined distance from the laser rangefinder system to the target.

15. The method of claim 14, wherein the environmental sensor comprises an inclinometer, thermometer, barometer, humidity sensor, compass, wind sensor, or any combination thereof.

16. The method of claim 14, further comprising causing a display of the laser rangefinder system to show the ballistic solution.

17. The method of claim 11, wherein each pulse of the plurality of pulses comprises an output pulse energy of at least 10 μJ.

18. The method of claim 11, wherein the fiber laser is configured to generate the laser light using a single mode fiber.

19. The method of claim 11, wherein the plurality of laser pulses are transmitted over a period of less than 200 ms.

20. The method of claim 11, wherein the plurality of laser pulses are transmitted at a rate of at least 25 kHz.
